(19) United States
(12) Patent Application Publication
(10) Pub. No.: US 2012/0176458 A1
(43) Pub. Date: Jul. 12, 2012

(54) APPARATUS INCLUDING UNIT CONTROLLING A THERMAL HEAD

(75) Inventor: Hiroyuki Abe, Shizuoka (JP)

(73) Assignee: NALTEC INC, Shizuoka-shi, Shizuoka (JP)

(21) Appl. No.: 13/387,456

(22) PCT Filed: Jun. 28, 2010
(86) PCT No.: PCT/JP2010/004253

§ 371 Date: Mar. 30, 2012

(30) Foreign Application Priority Data
Jul. 27, 2009 (JP) 2009-173978

(51) Int. Cl. B41J 2/355

(52) U.S. Cl. 347/211

(57) ABSTRACT

A unit (20) controlling a printer (1) includes: a unit (22) supplying a variable-period strobe signal, which is a strobe signal controlling an energization time of heating elements (11) and whose period is variable when forming an image with m tones, (m-1) times to a thermal head; a unit (21) supplying energization data, which is energization data controlling energization of the respective heating elements according to the strobe signal and includes (m-1) components for each of the heating elements, divided into the (m-1) times for each line to the thermal head; and a unit (23) supplying a latch signal with a variable period and latches components of the next energization data, to the thermal head in synchronization with the variable-period strobe signal.

### TECHNICAL FIELD

The present invention relates to an apparatus including a control unit that controls a thermal head.

### BACKGROUND ART

Japanese Laid-Open Patent Publication No. 2002-361921 discloses a sublimation-type thermal head printer with a thermal head on which a plurality of heating resistors are aligned. Such sublimation-type thermal head printer is characterized by preheating a sublimation ribbon using higher energy than the energy applied when reproducing tones until a predetermined temperature that is set in advance is reached.

### DISCLOSURE OF THE INVENTION

An apparatus, such as a printer, with a thermal head needs to be capable of favorably reproducing multiple tones.

One aspect of the present invention is an apparatus with a unit (control unit) that controls a thermal head. The thermal head includes heating elements for generating n dots disposed in a line. The control unit includes: a unit supplying a variable-period strobe signal, which is a strobe signal controlling an energization time of the heating elements and includes a period varying when forming an image with m tones, (m-1) times to the thermal head; a unit supplying energization data, which is energization data controlling energization of each of the n heating elements according to the strobe signal and includes (m-1) components for each of the n heating elements, divided into the (m-1) times for each line to the thermal head; and a unit supplying a latch signal, which latches components of the next energization data, with a variable period to the thermal head in synchronization with the variable-period strobe signal.

With this apparatus, it is possible to vary the period of the strobe signal in accordance with the characteristics of a medium (for example, thermal paper or a sublimation-type ink ribbon) used to print with the thermal head. Accordingly, it is possible to make the tone reproduction (i.e., changes in density) linear or close to linear. Typically, by using a variable-period strobe signal whose period becomes successively shorter, it is possible to increase the heating time for tone reproduction of light tones (low densities) and to shorten the heating time for tone reproduction of dark tones (high densities) and therefore possible to output the respective dots with the desired densities from a low density to a high density.

By using a variable-period strobe signal, it is possible to suppress situations where the emission of heat by the heating elements would become saturated at a darkest tone part if the period of the strobe signal were set in keeping with tone reproduction of a low density and where colors would not be outputted when outputting at low densities if the period of the strobe signal were set in keeping with tone reproduction of a high density. In other words, it is possible to suppress saturation at a dark tone part.

This apparatus also supplies a latch signal with a variable period to latch the next energization data in synchronization with the variable-period strobe signal. The period of the latch signal itself may become successively shorter or the period for supplying the latch signal may become shorter in synchronization with the strobe signal. By doing so, it is possible to reduce the wait time for the energization data for reproducing each tone. The time required for tone reproduction of low densities and the time required for tone reproduction of high densities also become variable. This means that even if the time required for tone reproduction of low densities is increased, it is possible to shorten the time required for tone reproduction of high densities. Accordingly, it is possible to reduce the time required for tone reproduction from low densities to high densities.

With this apparatus, one example of a variable period strobe signal is a strobe signal where the period becomes successively shorter. This is because with a thermal printing method that uses a sublimation ribbon or the like, longer time is required by tone reproduction (tonal printing) at low densities. The variable-period strobe signal may be a signal whose period becomes successively shorter or whose period varies in units of a plurality of cycles. As the strobe signal, as one example a signal with the same period may be outputted twice consecutively and then a signal with a shorter period may be outputted consecutively a plurality of times.

Another aspect of the present invention is an image generating apparatus, for example, a printer, including the apparatus described above and the thermal head.

Yet another aspect of the present invention is a method (control method) of controlling a thermal head including heating elements for generating n dots disposed in a line. This method includes following steps.

Supplying a variable-period strobe signal, which is a strobe signal controlling an energization time of the heating elements and whose period is variable when forming an image with m tones, (m-1) times to the thermal head.
Supplying energization data, which is energization data controlling energization of the heating elements respectively according to the strobe signal and includes (m-1) components for each of the heating elements, divided into the (m-1) times for each line to the thermal head.
Supplying a latch signal, which latches components of the next energization data, with a variable period to the thermal head in synchronization with the variable-period strobe signal.

Yet another aspect of the present invention is generating a multiple tone image using a thermal head including heating elements for generating n dots disposed in a line. This method includes following steps.

Supplying an (i-1)^{th} strobe signal for a variable-period strobe signal, which controls an energization time of the heating elements, is outputted (m-1) times when forming an image with m tones, and whose period is variable, to the thermal head.
Supplying i^{th} components of energization data, the energization data controlling energization of the heating elements respectively according to the strobe signal and including (m-1) components for each of the heating elements for each line, to the thermal head.
Supplying a latch signal, which latches the i^{th} components of the energization data, with a variable period to the thermal head in synchronization with an end of the (i-1)^{th} strobe signal.

With this method, since a variable period strobe signal is used, it is possible to vary the period of the strobe signal in accordance with the characteristics of a medium (for example, thermal paper or a sublimation-type ink ribbon) used to print with the thermal head. By using such a variable period strobe signal, it is possible to make the tone reproduction (i.e., changes in density) linear or close to linear. By also making the period of the latch signal variable, it is possible to reduce the wait time for the energization data and possible to suppress an increase in, and in some cases reduce, the print time in line units.

### BRIEF DESCRIPTION OF THE DRAWINGS

FIG. 1 is a block diagram showing one example of a printer according to the present invention.

FIG. 2 is a block diagram showing a thermal head and a control unit.

FIG. 3 is a flowchart for explaining one example of a control method according to the present invention.

FIG. 4(a) is a diagram schematically showing energization data, strobe signals, and latch signals of the printer that is one example of the present invention. FIG. 4(b) is a diagram schematically showing energization data and strobe signals of the other printer.

FIG. 5(a) is a graph showing the color-forming characteristics of a medium and shows the relationship between amount of heat and reproduction of tones. FIG. 5(b) is a graph showing the relationship between amount of heat and cycle numbers of energization for the printer that is one example of the present invention. FIG. 5(c) is a table showing a lookup table included in a strobe signal generating circuit in the printer that is one example of the present invention. FIG. 5(d) is a graph showing the relationship between cycle numbers of energization and reproduction of tones in the printer that is one example of the present invention.

FIG. 6(a) is a graph showing color-forming characteristics of a medium and shows the relationship between amount of heat and reproductions of tones. FIG. 6(b) is a graph showing the relationship between amount of heat and cycle numbers of energization for a conventional printer. FIG. 6(c) is a graph showing the relationship between cycle numbers of energization and reproduction of tones in the conventional printer.

### DETAIL DESCRIPTION

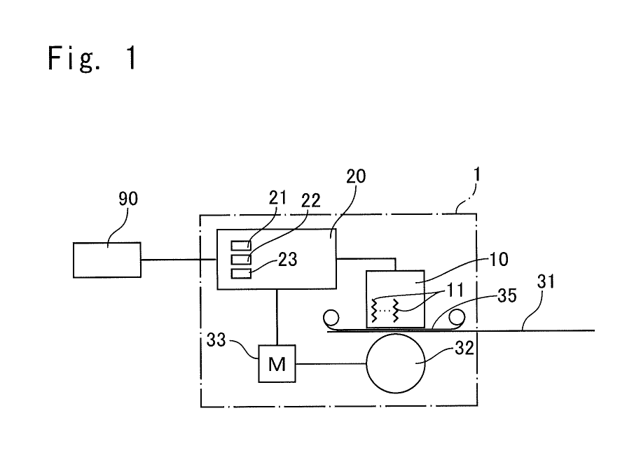

FIG. 1 shows an arrangement of one example of an image generating apparatus (typically a printer) according to the present invention. This image generating apparatus (typically a printer) 1 is a sublimation-type thermal printer and includes a line-type thermal head (thermal print head) 10 with n heating elements (or heaters, dot generating elements) 11 for generating dots that are aligned in a line, a platen roller 32 for conveying a recording medium (typically paper) 31, a multi-sublimation ribbon 35 for printing in multiple colors onto the paper 31, a motor 33 that drives the platen roller 32, and a control unit (or control apparatus) 20 controlling such components.

The control unit 20 acquires, from a host apparatus 90 such as a personal computer, data for printing an image including a variety of content such as images, characters, and the like, and based on such data, prints on the recording medium (paper) 31 using the thermal head 10. In this sublimation-type (or thermal transfer type, sublimation transfer type) printer 1, the ink ribbon (sublimation ribbon) 35 is heated as a medium (image forming medium) by thermal energy from the heating elements 11 and forms (generates) dots on the recording medium 31 by ink discharged from the ribbon 35. Another example of a medium heated by the thermal head 10 is thermal paper. If the medium is thermal paper, dots are formed (generated) to form an image on the surface of the thermal paper by heat energy supplied from the heating elements 11 that are arranged in a line. That is, in such case the thermal paper serves as both the image forming medium and the recording medium.

The control unit 20 includes a plurality of functional units 21, 22, and 23. The first functional unit 21 is an energization data generating unit or an energization data generating circuit that includes a function of generating (m-1) energization data φ1 for reproducing m tones for the n heating elements (dot generating elements) 11 and serially transferring the data (m-1) times for each line (in line units) to the thermal head 10. The second functional unit 22 is a strobe signal generating unit or a strobe signal generating circuit that includes a function of supplying strobe signals φ2 for controlling the energization time of the heating elements 11 in line units and reproducing tones in dot units in coordination with the energization data φ1.

The strobe signal generating unit 22 supplies the strobe signal φ2, which controls the energization time of the heating elements 11 and is a variable-period type strobe signal φ2 whose period is variable when generating an image with m tones, to the thermal head 10 (m-1) times. The energization data generating unit 21 supplies the energization data cp1, which controls the energization (i.e., the application of electrical power) to the individual heating elements 11 according to the strobe signal φ2 and includes (m-1) components for the respective heating elements 11, to the thermal head 10 split into (m-1) cycles for each line.

The third functional unit 23 is a latch signal generating unit or a latch signal generating circuit that includes a function of supplying, to the thermal head 10, a latch signal φ3 with a variable period for latching the energization data φ1 in synchronization with the variable-period strobe signal φ2. The latch signal generating unit 23 supplies, to the thermal head 10, the variable-period latch signal φ3 that latches the next component of the energization data φ1 in synchronization with the variable-period strobe signal φ2. An example of 16 tones (m=16) is described below as an example of multiple tones where the number “m” is 3 or higher.

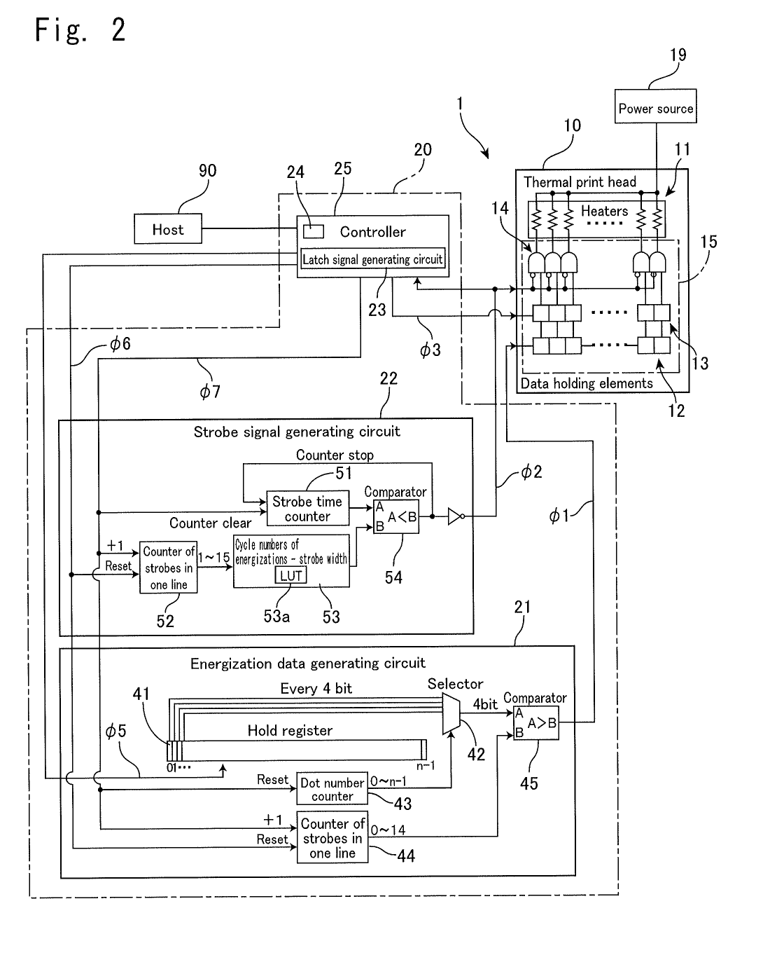

FIG. 2 shows the thermal head 10 and the control unit 20 by way of a block diagram. The thermal head 10 is a line thermal head and is capable of forming a plurality of dots that are aligned in the width direction (sub-scanning direction) of the paper 31 in line units (scan units). Although the thermal head 10 may form the dots included in a plurality of lines simultaneously, an example where printing (the formation of dots) is carried out in single line units is described below. Accordingly, the thermal head 10 includes a plurality (n) of heating elements 11 arranged relative to one another in a line. Each heating element 11 is individually supplied with power from a power supply 19.

The thermal head 10 includes a unit 15 that receives data including a plurality of binary components for on/off control of respective heating elements 11. The receiving unit 15 includes a plurality (n) of shift registers (data hold elements) 12, a plurality (n) of latch circuits 13, and a plurality (n) of gate circuits 14. The shift registers (data hold elements) are circuits that receive on/off data components, which are components included in the energization data φ1 and are supplied to the heating elements 11, and carry out serial-parallel conversion. The latch circuits 13 are circuits that correspond to the respective heating elements 11 and latch the components of the energization data φ1 that have been converted to parallel by the shift registers 12 using the latch signal φ3. The gate circuits 14 are circuits that control the energization of the respective heating elements 11 using the components of the energization data (pi latched by the respective latch circuits 13 and the strobe signal φ2 supplied commonly to lined heating elements. The gate circuits 14 supply power to the respective heating elements 11 to cause the individual heating elements 11 to heat up.

The control unit 20 includes the energization data generating unit (energization data generating circuit) 21, the strobe signal generating unit (strobe signal generating circuit) 22, and a CPU 25 including a function as the latch signal generating unit 23 that outputs the latch signal φ3. In this example, the CPU 25 includes the function as the latch signal generating unit 23 and also includes a print control unit (or “print control function”) 24. The print control unit 24 sets print data φ5 received from the host 90 into the energization data generating unit 21 in line units and outputs a reset signal φ6 that starts the printing of one line. When the strobe signal φ2 is time upped, the print control unit 24 outputs a control signal (strobe control signal) φ7 for outputting the next strobe signal. Note that the print data φ5 for printing one line in the present embodiment is 4 bits×n (numbered 0 to n-1) data that realizes 16 tones numbered 0 to 15. Note that “n” represents an integer.

The energization data generating circuit 21 outputs the energization data φ1. The energization data generating circuit 21 is a circuit for reproducing 16 (m=16) tones and generates the energization data (pi including fifteen components for representing 16 tones for each element in the n heating elements 11. In addition, the energization data generating circuit 21 serially transfers the energization data (pi to the thermal head 10 fifteen times for each line (in line units). The energization data generating circuit 21 includes a hold register 41 for holding data including 4 bits×n (numbered 0 to n-1) components that are the original image data, a selector 42 for selecting the data component of a predetermined dot in a line from the hold register 41, a dot number counter 43 for controlling the selector 42 and generating data for one line of dots, a counter 44 for counting the number of strobes in one line and generating the data of fifteen tones (i.e., the 0^{th} to 14^{th} tones) in order, and a comparator 45. The comparator 45 compares the output (i.e., “0” to “14”) of the counter 44 with the four-bit data (i.e., “0” to “15”) of the respective dots selected from the hold register 41 by the selector 42 and generates the energization data φ1 which includes a plurality of binary components for reproducing tones.

The print control function 24 of the CPU 25 sets the print data φ5 received from the host 90 in line units into the hold register 41 of the energization data generating circuit 21. After this, when the CPU 25 has outputted the reset signal φ6, the counter 44 of the energization data generating circuit 21 is reset and the first energization data φ1 (φ1.1) is outputted. Note that in the following description, when referring to the energization data in general, the expression “energization data φ1” is used, while when referring to data produced by dividing the energization data φ1 into a plurality of cycles for each line and outputting in order, the expression “energization data φ1.1” is used. This is also the case for other data.

The energization data φ1 is data including a plurality of binary on/off components and is divided into and outputted in (m-1), that is fifteen, cycles. Dots that are on in the first energization data cp1.1 are dots where the four-bit data in the hold register 41 is one to fifteen, that is, the dots whose tones are 1 to 15 out of the tones numbered 0 to 15. Dots where the four-bit data component in the hold register 41 is zero, that is, dots that are white (off) are off in the first energization data φ1.1. In the same way, dots where the four-bit data component in the hold register 41 is “1”, that is, dots with the lightest density in the grayscale are off in the second energization data φ1.2. Dots where the four-bit data component in the hold register 41 is “15”, that is, dots with the darkest density in the grayscale are on in the fifteenth energization data φ1.15 and other dots in the grayscale are off in the fifteenth energization data φ1.15.

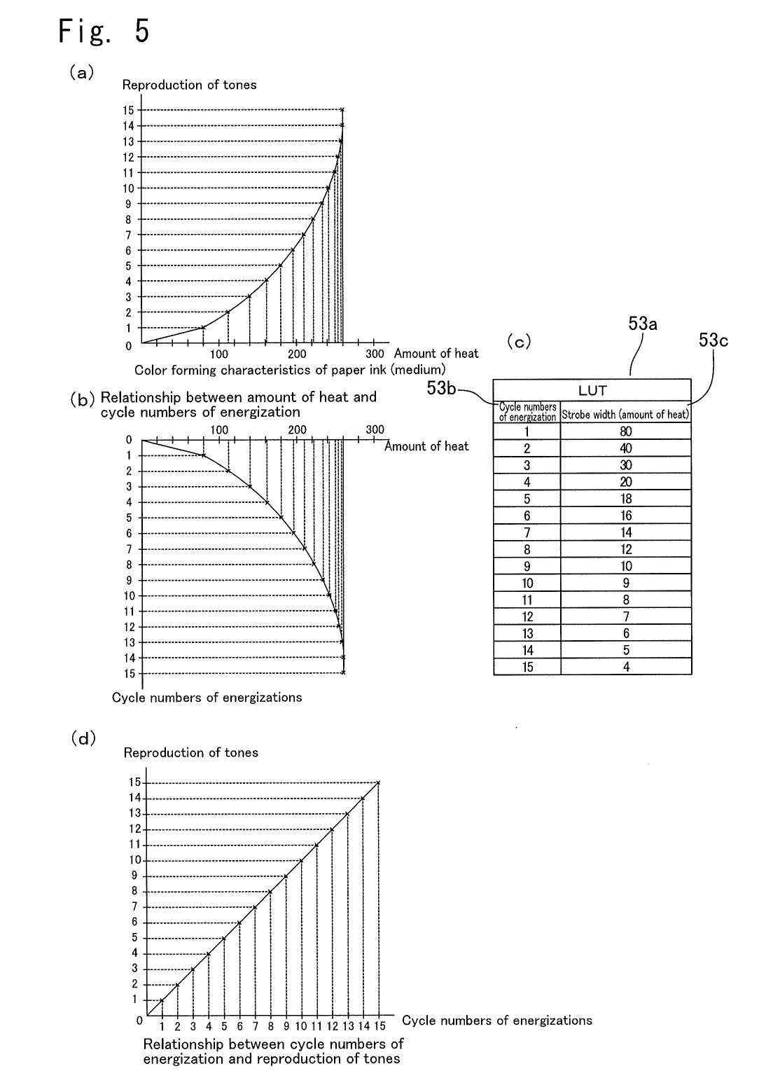

The strobe signal generating circuit 22 outputs variable-period strobe signals φ2 fifteen times (cycles) (first to fifteenth). The strobe signal φ2 is a signal that is common to lined heating elements 11, that is, n heating elements 11. The strobe signal generating circuit 22 includes a strobe time counter 51 that counts the output (holding) time of the strobe signal φ2, a strobe number counter 52 that counts the cycle numbers of energization in order to determine what number of strobe signal φ2 is generated in the order, a reference circuit 53 that outputs the scheduled holding time of the strobe signal φ2 corresponding to the cycle number of energization, and a comparator 54 that compares the scheduled holding time outputted from the reference circuit 53 and the holding time (continuous time) measured by the counter 51 and turns off the strobe signal φ2. The reference circuit 53 includes a lookup table (or “LUT”, see FIG. 5(c)) 53a which stores the relationship between the cycle numbers of energization and an amount of heat (strobe width).

In the LUT 53a, the relationships between cycle numbers of energization 53b and energization times (holding times, strobe widths) 53c that take into account the coloration characteristics of the medium (ribbon) 35 to be heated are set. As shown in FIG. 5(a), the coloration characteristics of the sublimation ribbon 35 are nonlinear with respect to the applied heat, and for a low density, that is, at the start of heating, larger amount of heat is required to achieve a predetermined density. The amount of heat generated by a heating element 11 increases substantially linearly with the heating time (the energization time). Accordingly, in the LUT 53a, conditions are set so that the energization time 53c is longer when the density is low (i.e., when the cycle number of energization is low) and the energization time 53c is shorter when the density is high (when the cycle number of energization is high). That is, the variable-period strobe signal φ2 outputted from the strobe signal generating circuit 22 in the present embodiment is a strobe signal whose period (holding time) becomes successively shorter.

The latch signal generating unit 23 realized by the CPU 25 outputs the latch signal φ3 in synchronization with the variable-period strobe signal φ2 outputted from the strobe signal generating circuit 22. More specifically, the latch signal generating unit 23 outputs the first latch signal φ3 that latches the first energization data φ1.1 for tone control following the reset signal φ6. Due to the reset signal φ6 and the first strobe control signal φ7 outputted from the print control unit 24, the first strobe signal φ2.1 is outputted from the strobe signal generating circuit 22. Due to the first strobe control signal φ7, the energization data generating circuit 21 generates and outputs the next energization data φ1.2.

The latch signal generating unit 23 rises (turns off) the variable-period strobe signal φ2.1 and after the energization time of the heating elements 11 has ended, outputs the latch signal φ3 once again. Accordingly, the latch signal φ3 is outputted with a variable period from the latch signal generating unit 23 of the CPU 25, supplied to the thermal head 10, and the next energization data φ1.2 is latched. Following the latch signal φ3, the next strobe control signal φ7 is outputted and the next strobe signal φ2.2 is outputted from the strobe signal generating circuit 22. In addition, the next energization data φ1.3 is generated and outputted by the energization data generating circuit 21.

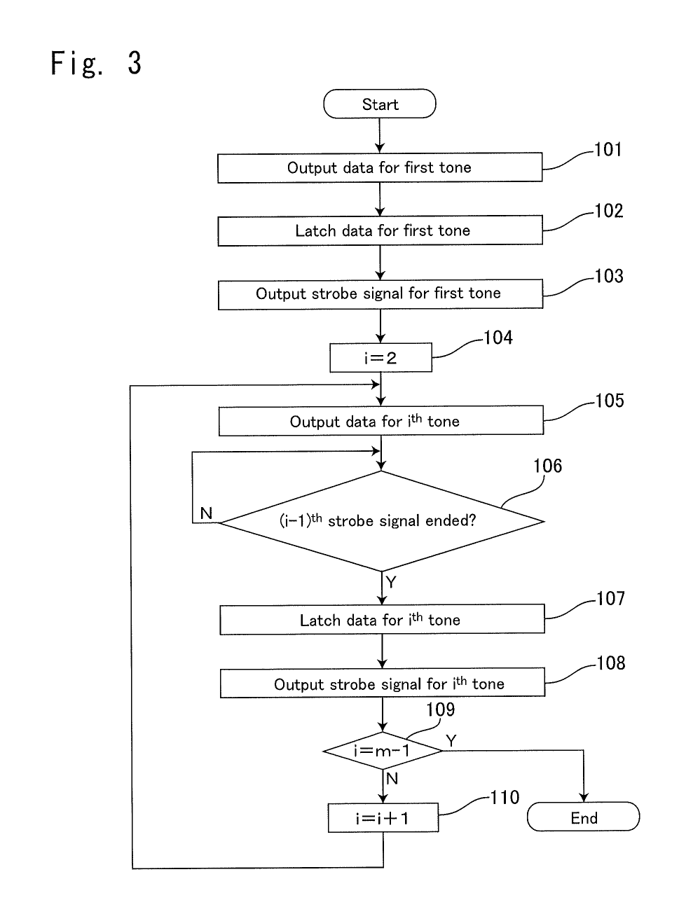

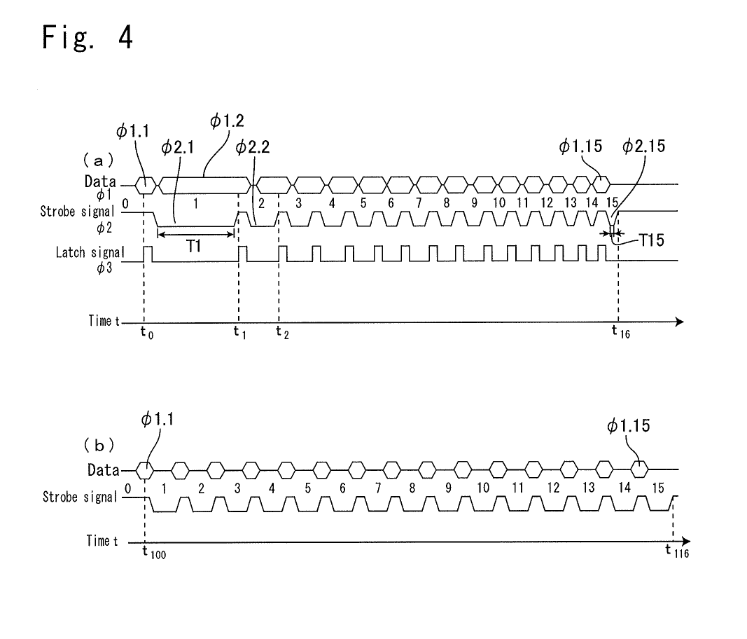

FIG. 3 is a flowchart for explaining one example of a control method according to the present invention. FIG. 4(a) schematically shows the waveforms of the energization data φ1.1 to 1.15 generated in the image generating apparatus (printer) 1 and outputted having been divided into multiple cycles, the variable-period strobe signals φ2.1 to 2.15, and the latch signal φ3. FIG. 4(b) schematically shows the waveforms of the energization data of a printer that uses fixed-period strobe signals and such strobe signals as information for comparison purposes. With the printer 1, as one example, the dots included in a line are formed in line units as described below.

First, in step 101 to step 103, the first density (i=1) out of 16 tones (m=16, i=0 to 15) is processed. Dots with the 0^{th} density, that is, dots that are white or off, are reproduced by not having a component in the energization data φ1. In step 101, the energization data generating circuit 21 outputs the energization data φ1.1 for the first tone that is supplied first. In step 102, as shown in FIG. 4(a), at time t0, the latch signal generating unit 23 outputs a signal φ3 that latches the energization data φ1.1 for the first tone. In step 103, the strobe signal generating circuit 22 outputs the strobe signal φ2.1 for the first tone.

Next, the second density (i=2) onwards are processed in order. In step 104, “i” is set at “2”. In step 105, the energization data generating circuit 21 outputs the energization data 0.2 for the second tone. The processing starts according to the strobe control signal φ7 for outputting the first strobe signal φ2.1.

In step 106, the latch signal generating unit 23 waits for the first strobe signal to end and in step 107, at time t1, outputs the signal φ3 for latching the energization data φ1.2 for the second tone (i.e., the next cycle). At the same time, or after a predetermined delay, the strobe control signal φ7 is outputted, and in step 108, the strobe signal generating circuit 22 outputs the strobe signal φ2.2 for the second tone. Due to the latched second energization data φ1.2 and the second strobe signal φ2.2, current flows to the heating elements 11 that develop (draw or reproduce) the “on” dots for the time set by the second strobe signal φ2.2 and such heating elements 11 emit heat. By doing so, reproduction (printing) of the second tone is executed.

In steps 109 and 110, the condition of the parameter “i” is determined and the processing in step 105 to step 108 is repeated (m-1, in this embodiment “15”) times. In step 105, the energization data generating circuit 21 outputs energization data φ1.i of the i^{th} tone, in step 106 the latch signal generating unit 23 waits for the (i-1)^{th} strobe signal to end, and in step 107 outputs the signal φ3 for latching the energization data φ1.1 of the next i^{th} tone. At the same time, or after a predetermined delay, the strobe control signal φ7 is outputted, and in step 108, the strobe signal generating circuit 22 outputs the strobe signal φ2.i of the i^{th} tone. Due to the latched i^{th} energization data φ1.i and the i^{th} strobe signal φ2.1, current flows to the heating elements 11 that develop (draw) the “on” dots for the time set by the second strobe signal φ2.1 and such heating elements 11 emit heat.

In this way, the printer 1 draws the dots of the first to the fifteenth tones (1 to 15 in the grayscale) according to the print data φ5 stored in the hold register 41 using the energization data cp1 and the strobe signal φ2 so as to become successively darker. When doing so, the printer 1 according to the present embodiment reproduces tones (prints tones) using a variable-period strobe signal φ2 where the on time (since a negative logic configuration is used, the time for which the strobe signal φ2.1 is at the low level) T1 of a light tone part (a low density, the strobe signal φ2.1) is longer than the on time T15 of the dark tone part (a high density, the strobe signal φ2.15).

That is, the printer 1 causes the heating elements 11 to emit heat using the strobe signal φ2 whose period becomes shorter in order from the low density reproduced first to the high density reproduced last, thereby heating the sublimation ribbon 35 and reproducing tones (carrying out tonal printing). In addition, the printer 1 latches the next energization data φ1 using the variable-period latch signal φ3 in synchronization with a rise (end) of the strobe signal φ2 of each cycle (reproduction of each tone).

For this reason, as shown in FIGS. 4(a) and (b), when looking at a part with a low density at the first stage of the reproduction of tones, the period of the strobe signal φ2 is long, so that when processing a low density, the printer 1 according to the present embodiment needs more time for printing than a conventional printer that uses a strobe signal with a fixed period. However, the periods of the strobe signal φ2 and the latch signal φ3 are variable and the time required by processing becomes gradually shorter as the density increases. This means that with the printer 1 according to the present embodiment, the processing time of high densities is shorter than with a conventional printer. Accordingly, for the total time required to form one dot in a multiple tone image, the printing time (time t0 to time t16) of the printer 1 according to the present embodiment is shorter than the printing time (time t100 to time t116) of a conventional printer, which means that the time required to print one line can be reduced.

In addition, by increasing the processing time of low densities, the printer 1 according to the present embodiment is capable of improving the resolution for low densities. By reducing the processing time for high densities, the printer 1 according to the present embodiment is also capable of suppressing saturation at high densities, by such saturation it becomes no longer possible to reproduce tones.

FIG. 5 shows data relating to the characteristics of the printer (image generating apparatus) 1 that is one example of the present invention. FIG. 5(a) is a graph showing the coloration characteristics of the medium (sublimation ribbon) 35 and shows the relationship between heat and tone (amount of heat and reproduction of tones). FIG. 5(b) is a graph showing the relationship between the amount of heat and the cycle numbers of energization for the printer 1. FIG. 5(c) is a table showing the content of a lookup table 53a included in the strobe signal generating circuit 22 of the printer 1. FIG. 5(d) is a graph showing the relationship between the cycle numbers of energization and the reproduction of tones for the printer 1.

As shown in FIG. 5(b) and FIG. 5(c), the printer 1 prints using the variable-period strobe signal φ2 whose period (or “on time”) differs in each energization cycle in order to reproduce tones. This means it is possible to control the relationship between the cycle numbers of energization and the amount of heat so as to become nonlinear. Accordingly, by using the medium 35 where the density (tone) relative to the amount of heat is nonlinear as shown in FIG. 5(a) to make the density (tone) relative to the cycle numbers of energization linear as shown in FIG. 5(d), it is possible to print a grayscale image, which requires the reproduction of tones, in accordance with the print data φ5.

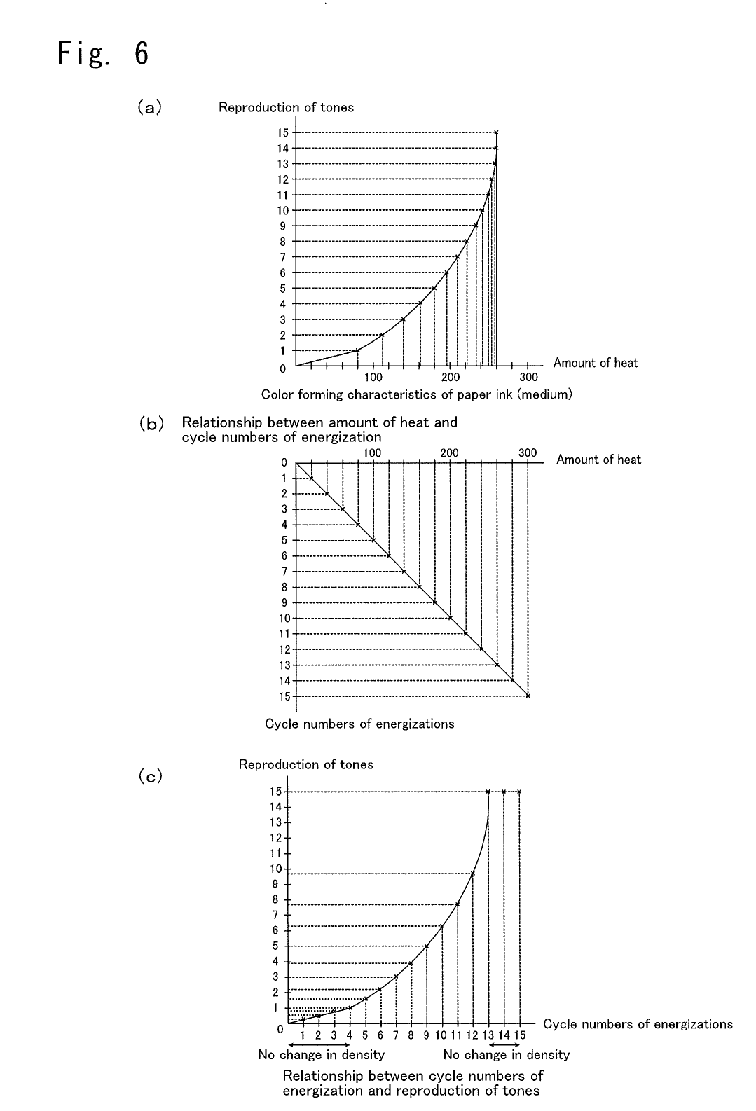

FIG. 6 is a diagram in which data relating to a conventional apparatus that prints using a strobe signal with a fixed period is collectively shown. FIG. 6(a) is a graph showing the color-forming characteristics of the medium (sublimation ribbon) 35 and shows the relationship between the amount of heat and the reproduction of tones. FIG. 6(b) is a graph showing the relationship between the amount of heat and the cycle numbers of energization for the conventional printer. FIG. 6(c) is a graph showing the relationship between the cycle numbers of energization and reproduction of tones for the conventional printer.[0041]

With the conventional apparatus, as shown in FIG. 6(b), a strobe signal with a fixed period is used and the cycle numbers of energization and the amount of heat are in a proportional relationship. Accordingly, with a medium 35 where the density (tone) is nonlinear with respect to the amount of heat, as shown in FIG. 6(c), the relationship between the cycle numbers of energization and the reproduction of tones is nonlinear, the heat is insufficient in light tone parts, resulting in little change in density, and saturation occurs at high tone parts, resulting in effectively no change in tone.

On the other hand, with the printer 1 according to the present embodiment, it is possible to vary the period of the strobe signal φ2 so as to correspond to the nonlinear characteristics of the medium 35 in use. Accordingly, since it is possible to sufficiently heat the medium 35 in light tone parts, it is possible to reproduce the resolution (grayscale) of the dots in the light tone parts much more faithfully. Also, since it is possible to suppress saturation of color for the medium 35 in the dark tone parts, it is possible to reproduce the resolution (grayscale) of the dots in the dark tone parts much more faithfully. Since the production of color by the medium 35 can be controlled so as to be linear with respect to the number of energizations across the entire range from the light tone parts to the dark tone parts, it is possible to reproduce a grayscale that is faithful to the print data φ5 across the entire tonal range.

In addition, according to the printer 1 of the present embodiment and the control method thereof, the period of the latch signal φ3 is varied in synchronization with the period of the strobe signal φ2. This means that even if a strobe signal φ2 with a long on time (i.e., a long period) is used to faithfully reproduce light tone parts, it is still possible to suppress any overall increase in the time required to form one dot (one line). On the other hand, by setting a short period for the strobe signal φ2 for reproducing dark tone parts, it is possible to reduce the time required to form one dot (one line). In addition, by setting a short period for the strobe signal φ2 for reproducing dark tone parts, it is possible to achieve an effect whereby even the dark tone parts can be faithfully reproduced.

Note that although a sublimation-type line thermal printer that uses a sublimation ribbon has been described in the present embodiment, the present invention can be applied in the same way to a line thermal printer that prints onto a medium with predetermined color-forming characteristics with respect to heat, such as thermal paper. The present invention is also not limited to a line thermal printer and can be applied to a serial-type printer where a head moves reciprocally in the scanning direction. The printer is also not limited to a personal printer and may be a multifunctional device or a commercial printer.

1. An apparatus including a control unit that controls a thermal head including heating elements for generating n dots disposed in a line, the control unit comprising:
a unit supplying a variable-period strobe signal, which is a strobe signal controlling an energization time of the heating elements and includes a period varying when forming an image with m tones, (m-1) times to the thermal head;
a unit supplying energization data, which is energization data controlling energization of the heating elements respectively according to the strobe signal and includes (m-1) components for each of the heating elements, divided into the (m-1) times for each line to the thermal head; and
a unit supplying a latch signal, which latches components of next energization data, with a variable period to the thermal head in synchronization with the variable-period strobe signal.

2. The apparatus according to claim 1, wherein the variable-period strobe signal is a strobe signal including a period becomes successively shorter.

3. An image generating apparatus comprising:
an apparatus according to claim 1; and the thermal head.

4. A method of controlling a thermal head including heating elements for generating n dots disposed in a line, comprising:
supplying a variable-period strobe signal , which is a strobe signal controlling an energization time of the heating elements and includes a period varying when forming an image with m tones, (m-1) times to the thermal head;
supplying energization data, which is energization data controlling energization of the heating elements respectively according to the strobe signal and includes (m-1) components for each of the heating elements, divided into the (m-1) times for each line to the thermal head; and
supplying a latch signal, which latches components of next energization data, with a variable period to the thermal head in synchronization with the variable-period strobe signal.

5. The method according to claim 4, wherein the variable-period strobe signal is a strobe signal including a period becomes successively shorter.

6. A method of generating a multiple tone image using a thermal head including heating elements for generating n dots disposed in a line, comprising:
supplying an (i-1)th strobe signal for a variable-period strobe signal, which controls an energization time of the heating elements, is outputted (m-1) times when forming an image with m tones, and whose period is variable, to the thermal head;
supplying ith components of energization data, which is energization data controlling energization of the heating elements respectively according to the variable-period strobe signal and includes (m-1) components for each of the heating elements for each line, to the thermal head; and supplying a latch signal, which latches the ith components of the energization data, with a variable period to the thermal head in synchronization with an end of the (i-1)th strobe signal.
